(19) United States
(12) Patent Application Publication
(10) Pub. No.: US 2026/0322271 A1
(43) Pub. Date: Oct. 15, 2026

(54) MULTI-PHASE POWER CONVERTER

(71) Applicant: ANPEC ELECTRONICS CORPORATION, HSINCHU (TW)

(72) Inventor: FU-CHUAN CHEN, Hsinchu City (TW)

(21) Appl. No.: 19/226,168

(22) Filed: Jun. 3, 2025

(30) Foreign Application Priority Data
Apr. 14, 2025 (TW) 114113943

(51) Int. Cl. H02M 3/158; H02M 1/00

(52) U.S. Cl. CPC H02M 3/1586; H02M 1/0016

(57) ABSTRACT

A multi-phase power converter includes a plurality of switch components as a buck high-side switch, a buck low-side switch, a boost high-side switch and a boost low-side switch, and a control circuit. A first terminal of the buck high-side switch is coupled to an input voltage. A first terminal of the buck low-side switch is connected to a second terminal of the buck high-side switch. A first terminal of the boost low-side switch is connected to a second terminal of the boost high-side switch. Second terminals of the buck low-side switches are respectively connected to first terminals of inductors. Second terminals of the boost low-side switches are respectively connected to second terminals of the inductors. The control circuit controls each of these switch components according to a voltage of a first terminal of the boost high-side switch.

### CROSS-REFERENCE TO RELATED PATENT APPLICATION

This application claims the benefit of priority to Taiwan Patent Application No. 114113943, filed on Apr. 14, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power converter, and more particularly to a multi-phase power converter.

### BACKGROUND OF THE DISCLOSURE

Power converters are indispensable for electronic devices. The power converters are used to adjust power and supply the adjusted power to the electronic devices. The power converter is generally a single-phase power converter. In recent years, multi-phase power converters have been developed for various application requirements.

However, internal configurations and control manners of conventional multi-phase power converters are still simplistic and cannot be easily expanded for adapting to a broader range of applications. In the control manner of the conventional multi-phase power converter, a plurality of slopes of a plurality of waveform segments of each one of a plurality of waveforms of a current flowing to an inductor from a plurality of switch components cannot be controlled to be equal to that of another of the plurality of waveforms of the current. Therefore, the current of the conventional multi-phase power converter fluctuates unstably.

### SUMMARY OF THE DISCLOSURE

In response to the above-referenced technical inadequacies, the present disclosure provides a multi-phase power converter. The multi-phase power converter includes a plurality of phase switch circuits, a control circuit and a plurality of inductors. Each of the plurality of inductors includes a first terminal and a second terminal. Each of the plurality of phase switch circuits includes two buck-side switches respectively as a buck high-side switch and a buck low-side switch. A first terminal of the buck high-side switch is coupled to an input voltage. A first terminal of the buck low-side switch is connected to a second terminal of the buck high-side switch. A second terminal of the buck low-side switch is grounded. The first terminals of the buck high-side switches of the plurality of phase switch circuits are respectively connected to the first terminals of the plurality of inductors. Each of the plurality of phase switch circuits includes two boost-side switches respectively as a boost high-side switch and a boost low-side switch. A first terminal of the boost high-side switch is connected to an output node. A first terminal of the boost low-side switch is connected to a second terminal of the boost high-side switch. A second terminal of the boost low-side switch is grounded. The first terminals of the boost low-side switches of the plurality of phase switch circuits are respectively connected to the second terminals of the plurality of inductors. The control circuit is connected to a control terminal of each of the two buck-side switches of each of the plurality of phase switch circuits, a control terminal of each of the two boost-side switches of each of the plurality of phase switch circuits and the output node. The control circuit is configured to control the two buck-side switches and the two boost-side switches of each of the plurality of phase switch circuits according to an output voltage of the output node.

In order to solve the above-mentioned problems, one of the technical aspects adopted by the present disclosure is to provide a multi-phase power converter. The multi-phase power converter includes two phase switch circuits respectively as a first phase switch circuit and a second phase switch circuit, and a control circuit. Each of the plurality of phase switch circuits includes two buck-side switches respectively as a buck high-side switch and a buck low-side switch. A first terminal of the buck high-side switch is coupled to an input voltage. A first terminal of the buck low-side switch is connected to a second terminal of the buck high-side switch. A second terminal of the buck low-side switch is grounded. The first phase switch circuit further includes two boost-side switches respectively as a boost high-side switch and a boost low-side switch. A first terminal of the boost high-side switch is connected to an output node. A first terminal of the boost low-side switch is connected to a second terminal of the boost high-side switch. A second terminal of the boost low-side switch is grounded. The first terminal of the buck low-side switch of the first phase switch circuit is connected to a first terminal of a first inductor. The first terminal of the boost low-side switch of the first phase switch circuit is connected to a second terminal of the first inductor. The second terminal of the first inductor is further connected to a first terminal of a second inductor. A second terminal of the second inductor is connected to the first terminal of the buck low-side switch of the second phase switch circuit. The control circuit is connected to a control terminal of each of the two buck high-side switches of each of the plurality of phase switch circuits, a control terminal of each of the two boost-side switches, and the output node. The control circuit is configured to control the two buck high-side switches of each of the plurality of phase switch circuits and the two boost-side switches according to an output voltage of the output node.

In order to solve the above-mentioned problems, one of the technical aspects adopted by the present disclosure is to provide a multi-phase power converter. The multi-phase power converter includes two phase switch circuits respectively as a first phase switch circuit and a second phase switch circuit, and a control circuit. Each of the plurality of phase switch circuits includes two boost-side switches respectively as a boost high-side switch and a boost low-side switch. A first terminal of the boost high-side switch is connected to an output node. A first terminal of the boost low-side switch is connected to a second terminal of the boost high-side switch. A second terminal of the boost low-side switch is grounded. The first phase switch circuit includes two buck-side switches respectively as a buck high-side switch and a buck low-side switch. A first terminal of the buck high-side switch is coupled to an input voltage. A first terminal of the buck low-side switch is connected to a second terminal of the buck high-side switch. A second terminal of the buck low-side switch is grounded. The first terminal of the buck low-side switch is connected to a first terminal of a first inductor. The first terminal of the boost low-side switch of the first phase switch circuit is connected to a second terminal of the first inductor. The first terminal of the boost low-side switch of the second phase switch circuit is connected to a first terminal of a second inductor. A second terminal of the second inductor is connected to the first terminal of the first inductor. The control circuit is connected to a control terminal of each of the two boost-side switches of each of the plurality of phase switch circuits, a control terminal of each of the two buck-side switches and the output node. The control circuit is configured to control the two boost-side switches of each of the plurality of phase switch circuits and the two buck-side switches according to an output voltage of the output node.

As described above, the present disclosure provides the multi-phase power converter. The multi-phase power converter of the present disclosure includes the plurality of phase switch circuits. In the multi-phase power converter of the present disclosure, the control circuit performs phase-splitting control on the plurality of phase switching circuits. The multi-phase power converter switches between the boost mode, the buck mode and the buck-boost mode, and supplies appropriates voltages. The multi-phase power converter of the present disclosure only includes two phase switch circuits or can be easily scaled to include more phase switch circuits for different practical applications. Furthermore, in the multi-phase power converter of the present disclosure, the number of the buck-side switch circuits and the number of the boost-side switch circuits of each of the plurality of phase switch circuits depend on the boost mode or buck mode as a main application requirement.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a multi-phase power converter according to a first embodiment of the present disclosure;

FIG. 2 is a circuit diagram of a control circuit of the multi-phase power converter according to the first embodiment of the present disclosure;

FIG. 3 is a waveform diagram of a comparing signal and a plurality of phase split signals of the multi-phase power converter according to the first embodiment of the present disclosure;

FIG. 4 is a waveform diagram of signals of the multi-phase power converter in a buck mode according to the first embodiment of the present disclosure;

FIG. 5 is a waveform diagram of signals of the multi-phase power converter in a boost mode according to the first embodiment of the present disclosure;

FIG. 6 is a waveform diagram of signals of the multi-phase power converter in a buck-boost mode according to the first embodiment of the present disclosure;

FIG. 7 is a circuit diagram of a multi-phase power converter according to a second embodiment of the present disclosure;

FIG. 8 is a circuit diagram of a control circuit of the multi-phase power converter according to the second embodiment of the present disclosure;

FIG. 9 is a waveform diagram of signals of the multi-phase power converter in a buck mode according to the second embodiment of the present disclosure;

FIG. 10 is a waveform diagram of signals of the multi-phase power converter in a boost mode according to the second embodiment of the present disclosure;

FIG. 11 is a waveform diagram of signals of the multi-phase power converter in a buck-boost mode according to the second embodiment of the present disclosure;

FIG. 12 is a circuit diagram of a multi-phase power converter according to a third embodiment of the present disclosure;

FIG. 13 is a circuit diagram of a control circuit of the multi-phase power converter according to the third embodiment of the present disclosure;

FIG. 14 is a waveform diagram of signals of the multi-phase power converter in a buck mode according to the third embodiment of the present disclosure;

FIG. 15 is a waveform diagram of signals of the multi-phase power converter in a boost mode according to the third embodiment of the present disclosure;

FIG. 16 is a waveform diagram of signals of the multi-phase power converter in a buck-boost mode according to the third embodiment of the present disclosure;

FIG. 17 is a circuit diagram of a multi-phase power converter according to a fourth embodiment of the present disclosure;

FIG. 18 is a circuit diagram of a control circuit of the multi-phase power converter according to the fourth embodiment of the present disclosure;

FIG. 19 is a waveform diagram of signals of the multi-phase power converter according to the fourth embodiment of the present disclosure;

FIG. 20 is a circuit diagram of a multi-phase power converter according to a fifth embodiment of the present disclosure;

FIG. 21 is a circuit diagram of a control circuit of the multi-phase power converter according to the fifth embodiment of the present disclosure;

FIG. 22 is a waveform diagram of signals of the multi-phase power converter according to the fifth embodiment of the present disclosure;

FIG. 23 is a circuit diagram of a multi-phase power converter according to a sixth embodiment of the present disclosure;

FIG. 24 is a circuit diagram of a control circuit of the multi-phase power converter according to the sixth embodiment of the present disclosure; and

FIG. 25 is a waveform diagram of signals of the multi-phase power converter according to the sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

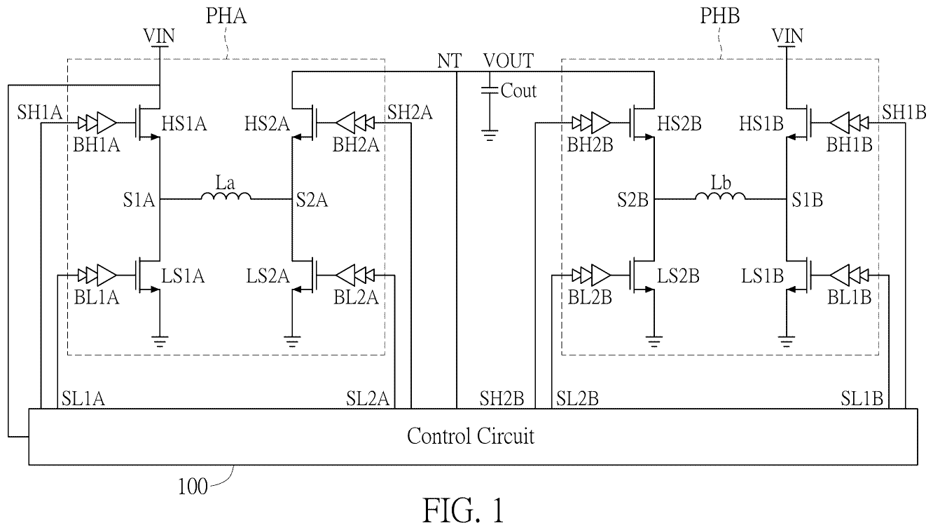

Reference is made to FIG. 1, which is a circuit diagram of a multi-phase power converter according to a first embodiment of the present disclosure.

The multi-phase power converter of the present disclosure includes a plurality of phase switch circuits and a plurality of inductors. As shown in FIG. 1, in the first embodiment, the multi-phase power converter of the present disclosure includes two phase switch circuits respectively as a first phase switch circuit PHA and a second phase switch circuit PHB, two inductors respectively as a first inductor La and a second inductor Lb, and a control circuit 100.

In the first embodiment, the multi-phase power converter of the present disclosure includes two buck-side switch circuits and two boost-side switch circuits. One of the two buck-side switch circuits includes a buck high-side switch HS1A and a buck low-side switch LS1A of the first phase switch circuit PHA. The other of the two buck-side switch circuits includes a buck high-side switch HS1B and a buck low-side switch LS1B of the second phase switch circuit PHB. One of the two boost-side switch circuits includes a boost high-side switch HS2A and a boost low-side switch LS2A of the first phase switch circuit PHA. The other of the two boost-side switch circuits includes a boost high-side switch HS2B and a boost low-side switch LS2B of the second phase switch circuit PHB.

If necessary, the multi-phase power converter of the present disclosure may further include one buffer or a plurality of buffers, such as, but not limited to, a plurality of buffers BH1A, BL1A, BH2A, BL2A, BH1B, BL1B, BH2B, BL2B shown in FIG. 1. Each of the plurality of buffers includes an input terminal and an output terminal. The input terminals of the plurality of buffers are respectively connected to a plurality of output terminals of the control circuit 100. The output terminals of the plurality of buffers are respectively connected to control terminals of a plurality of switch components (including the buck high-side switch HS1A, the buck low-side switch LS1A, the boost high-side switch HS2A, the boost low-side switch LS2A, the buck high-side switch HS1B, the buck low-side switch LS1B, the boost high-side switch HS2B and the boost low-side switch LS2B).

A first terminal of the buck high-side switch HS1A is coupled to an input voltage VIN. A first terminal of the buck low-side switch LS1A is connected to a second terminal of the buck high-side switch HS1A and a first terminal of the first inductor La. A first terminal of the boost high-side switch HS2A is connected to an output node NT. A first terminal of the boost low-side switch LS2A is connected to a second terminal of the boost high-side switch HS2A and a second terminal of the first inductor La. A second terminal of the buck low-side switch LS1A and a second terminal of the boost low-side switch LS2A are grounded.

A first terminal of the buck high-side switch HS1B is coupled to the input voltage VIN. A first terminal of the buck low-side switch LS1B is connected to a second terminal of the buck high-side switch HS1B and a second terminal of the second inductor Lb. A first terminal of the boost high-side switch HS2B is connected to the output node NT. A first terminal of the boost low-side switch LS2B is connected to a second terminal of the boost high-side switch HS2B and a first terminal of the second inductor Lb. A second terminal of the buck low-side switch LS1B and a second terminal of the boost low-side switch LS2B are grounded.

If necessary, the multi-phase power converter of the present disclosure may further include an output circuit. The output circuit is connected between the output node NT and a ground. For example, the output circuit may include an output capacitor Cout shown in FIG. 1. A first terminal of the output capacitor Cout is connected to the output node NT, and a second terminal of the output capacitor Cout is grounded. In practice, the output capacitor Cout may be replaced with one or more resistors or a voltage divider circuit, or the output circuit may further include the one or more resistors or the voltage divider circuit.

An input terminal of the control circuit 100 is connected to the output node NT (or the voltage divider circuit). A power terminal of the control circuit 100 is coupled to the input voltage VIN. The plurality of output terminals of the control circuit 100 are connected to the control terminals of the plurality of switch components (through the plurality of buffers) respectively.

The control circuit 100 may use the input voltage VIN, and may output a plurality of control signals respectively to the control terminals of the plurality of switch components according to an output voltage VOUT from the output node NT for controlling the plurality of switch components.

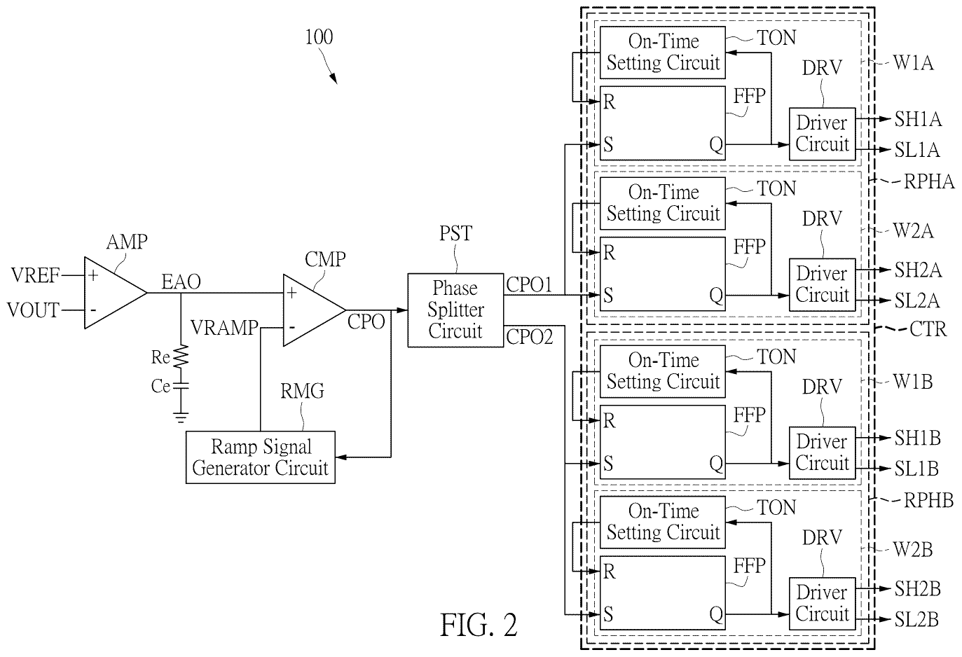

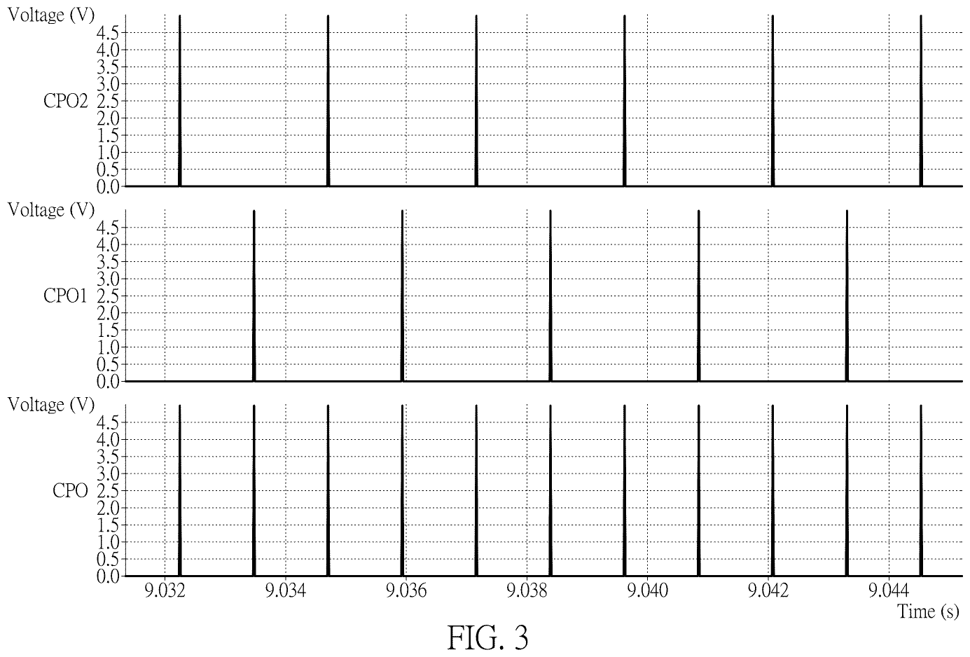

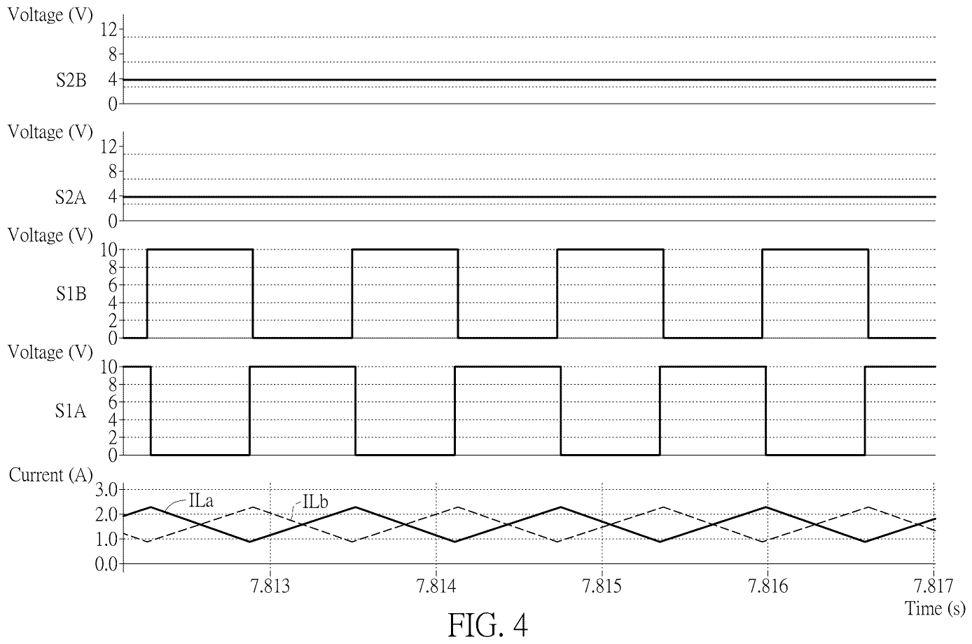

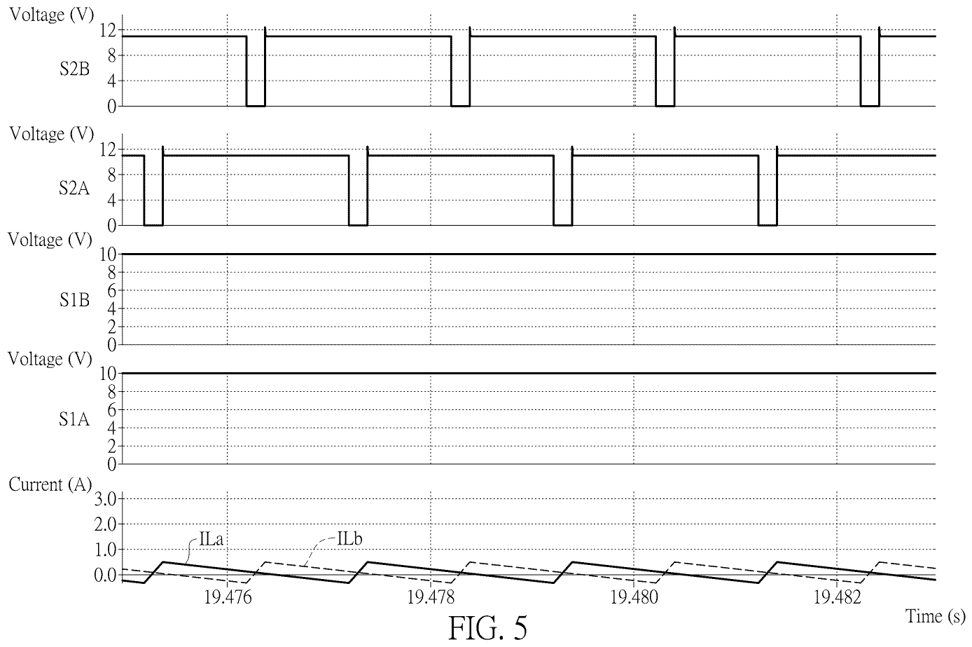

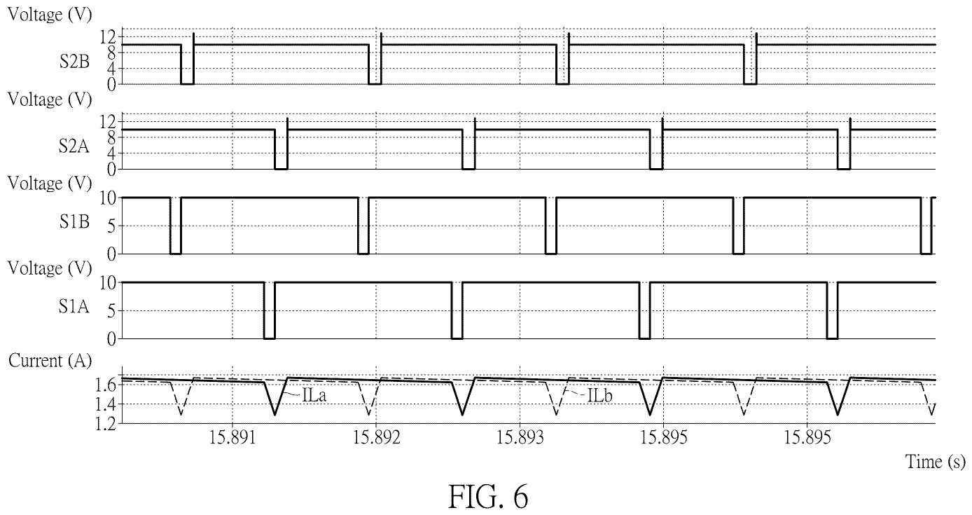

Reference is made to FIG. 1 to FIG. 6, in which FIG. 2 is a circuit diagram of a control circuit of the multi-phase power converter according to the first embodiment of the present disclosure, FIG. 3 is a waveform diagram of a comparing signal and a plurality of phase split signals of the multi-phase power converter according to the first embodiment of the present disclosure, FIG. 4 is a waveform diagram of signals of the multi-phase power converter in a buck mode according to the first embodiment of the present disclosure, FIG. 5 is a waveform diagram of signals of the multi-phase power converter in a boost mode according to the first embodiment of the present disclosure, and FIG. 6 is a waveform diagram of signals of the multi-phase power converter in a buck-boost mode according to the first embodiment of the present disclosure.

For example, the control circuit 100 shown in FIG. 1 may be the same as the control circuit 100 shown in FIG. 2. As shown in FIG. 2, the control circuit 100 includes an error amplifier AMP, a comparator CMP, a phase splitter circuit PST and a boost-buck control circuit CTR.

A first input terminal such as a non-inverting input terminal of the error amplifier AMP is coupled to a reference voltage VREF. A second input terminal, such as an inverting input terminal of the error amplifier AMP shown in FIG. 2, is connected to the output node NT shown in FIG. 1. The second input terminal of the error amplifier AMP receives the output voltage VOUT from the output node NT as shown in FIG. 2, or in practice, receives a divided voltage of the output voltage VOUT from the voltage divider circuit. A first input terminal such as a non-inverting input terminal of the comparator CMP is connected to an output terminal of the error amplifier AMP. A second input terminal such as an inverting input terminal of the comparator CMP may be coupled to a ramp voltage VRAMP.

The error amplifier AMP multiplies a difference between the output voltage VOUT (or the divided voltage of the output voltage VOUT) and the reference voltage VREF by a gain to output an error amplified signal EAO. The comparator CMP compares a voltage of the error amplified signal EAO from the output terminal of the error amplifier AMP with the ramp voltage VRAMP to output a comparing signal CPO.

If necessary, the control circuit 100 may further include a first resistor Re, a first capacitor Ce, a ramp signal generator circuit RMG or any combination thereof. A first terminal of the first resistor Re is connected to the output terminal of the error amplifier AMP. A second terminal of the first resistor Re is connected to a first terminal of the first capacitor Ce. A second terminal of the first capacitor Ce is grounded.

An input terminal of the ramp signal generator circuit RMG may be connected to an output terminal of the comparator CMP. An output terminal of the ramp signal generator circuit RMG may be connected to the second input terminal such as the inverting input terminal of the comparator CMP. The ramp signal generator circuit RMG may, according to the comparing signal CPO from the output terminal of the comparator CMP, modulate a voltage value of the ramp voltage VRAMP of a ramp signal and output the ramp signal to the second input terminal such as the inverting input terminal of the comparator CMP.

It is worth noting that, the phase splitter circuit PST is connected to the output terminal of the comparator CMP. The phase splitter circuit PST splits the comparing signal CPO into two phase split signals CPO1, CPO2. A plurality of phases of a plurality of waveforms of the phase split signal CPO1 are not overlapped with a plurality of phases of a plurality of waveforms of the phase split signal CPO2. For example, as shown in FIG. 3, the phase splitter circuit PST alternately distributes a plurality of waveforms of the comparing signal CPO to the two phase splitting signals CPO1, CPO2. The plurality of waveforms of the phase split signal CPO1 are not overlapped with the plurality of waveforms of the phase split signal CPO2 on a time axis. Therefore, in the multi-phase power converter, the first phase switch circuit PHA and the second phase switch circuit PHB are alternately controlled.

The boost-buck control circuit CTR shown in FIG. 2 is connected to the phase splitter circuit PST shown in FIG. 2, and is connected to the control terminal of each of the plurality of switch components.

For example, as shown in FIG. 2, the boost-buck control circuit CTR includes two phase control circuits respectively as a first phase control circuit RPHA and a second phase control circuit RPHB. The first phase control circuit RPHA receives the phase split signal CPO1 from the phase splitter circuit PST. The second phase control circuit RPHB receives the phase split signal CPO2 from the phase splitter circuit PST.

The first phase control circuit RPHA includes two switch control circuits W1A, W2A. The first phase control circuit RPHA includes two switch control circuits W1B, W2B. The switch control circuit W1A is a first phase buck-side control circuit. The switch control circuit W2A is a first phase boost-side control circuit. The switch control circuit W1B is a second phase buck-side control circuit. The switch control circuit W2B is a second phase boost-side control circuit.

Each of the plurality of switch control circuits W1A, W2A, W1B, W2B includes an on-time setting circuit TON, an on-time signal generator circuit FFP and a driver circuit DRV. For example, the on-time signal generator circuit FFP may be an SR flip-flop shown in FIG. 2 or other circuit components in practice.

A set terminal S of the on-time signal generator circuit FFP of each of the plurality of switch control circuits W1A, W2A is connected to a first output terminal of the phase splitter circuit PST, and receives the phase split signal CPO1 from the first output terminal of the phase splitter circuit PST. The set terminal S of the on-time signal generator circuit FFP of each of the plurality of switch control circuits W1B, W2B is connected to a second output terminal of the phase splitter circuit PST, and receives the phase split signal CPO2 from the second output terminal of the phase splitter circuit PST.

In each of the plurality of switch control circuits W1A, W2A, W1B, W2B, an output terminal Q of the on-time signal generator circuit FFP is connected to an input terminal of the on-time setting circuit TON and an input terminal of the driver circuit DRV, and an output terminal of the on-time setting circuit TON is connected to a reset terminal R of the on-time signal generator circuit FFP.

The on-time setting circuit TON of each of the plurality of switch control circuits W1A, W2A, W1B, W2B outputs an on-time set signal. The on-time signal generator circuit FFP of each of the plurality of switch control circuits W1A, W2A outputs an on-time signal based on the phase split signal CPO1 and the on-time set signal. The on-time signal generator circuit FFP of each of the plurality of switch control circuits W1B, W2B outputs an on-time signal based on the phase split signal CPO2 and the on-time set signal.

The driver circuit DRV of the switch control circuit W1A, according to the on-time signal from the output terminal Q of the on-time signal generator circuit FFP, outputs a control signal SH1A to the control terminal of the buck high-side switch HS1A and outputs a control signal SL1A to the control terminal of the buck high-side switch LS1A.

The driver circuit DRV of the switch control circuit W2A, according to the on-time signal from the output terminal Q of the on-time signal generator circuit FFP, outputs a control signal SH2A to the control terminal of the boost high-side switch HS2A and outputs a control signal SL2A to the control terminal of the boost high-side switch LS2A.

The driver circuit DRV of the switch control circuit W1B, according to the on-time signal from the output terminal Q of the on-time signal generator circuit FFP, outputs a control signal SH1B to the control terminal of the buck high-side switch HS1B and outputs a control signal SL1B to the control terminal of the buck high-side switch LS1B.

The driver circuit DRV of the switch control circuit W2B, according to the on-time signal from the output terminal Q of the on-time signal generator circuit FFP, outputs a control signal SH2B to the control terminal of the boost high-side switch HS2B and outputs a control signal SL2B to the control terminal of the boost high-side switch LS2B.

The control circuit 100 of the multi-phase power converter of the first embodiment of the present disclosure is able to operate in the buck mode, the boost mode and the buck-boost mode.

In the buck mode, a second phase boost-side signal S2B, a first phase boost-side signal S2A, a second phase buck-side signal S1B, a first phase buck-side signal S1A, a current ILa flowing through the first inductor La and a current ILb flowing through the second inductor Lb are shown in FIGS. 1 and 4.

In the boost mode, the second phase boost-side signal S2B, the first phase boost-side signal S2A, the second phase buck-side signal S1B, the first phase buck-side signal S1A, the current ILa and the current ILb are shown in FIGS. 1 and 5.

In the buck-boost mode, the second phase boost-side signal S2B, the first phase boost-side signal S2A, the second phase buck-side signal S1B, the first phase buck-side signal S1A, the current ILa and the current ILb are shown in FIGS. 1 and 6.

It is worth noting that, in the multi-phase power converter of the first embodiment of the present disclosure, each of a plurality of waveforms of the currents ILa, ILb has a plurality of waveform segments, and slopes of the plurality of waveform segments are different from each other. The slopes of the plurality of waveform segments of each one of the plurality of waveforms of each of the currents ILa, ILb are respectively equal to the slopes of the plurality of waveform segments of another of the plurality of waveforms of each of the currents ILa, ILb. Accordingly, the currents ILa, ILb of the multi-phase power converter of the present disclosure change stably.

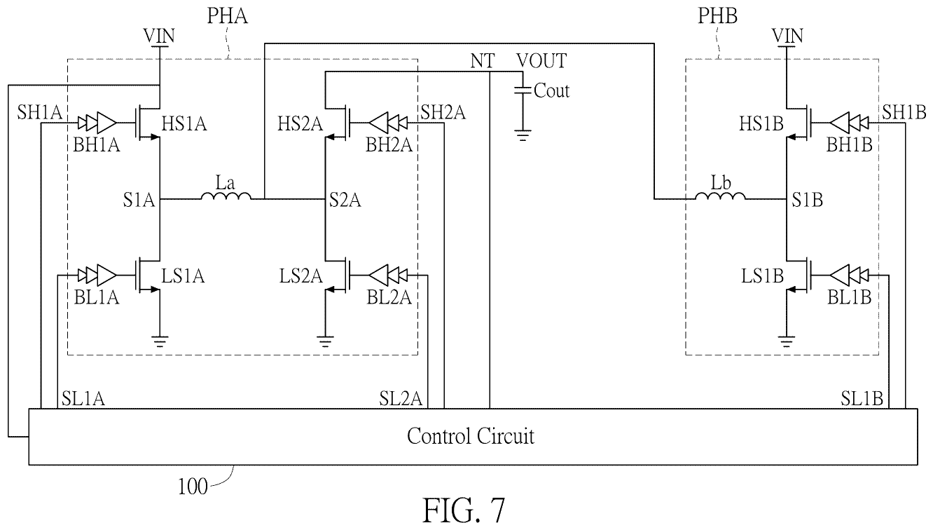

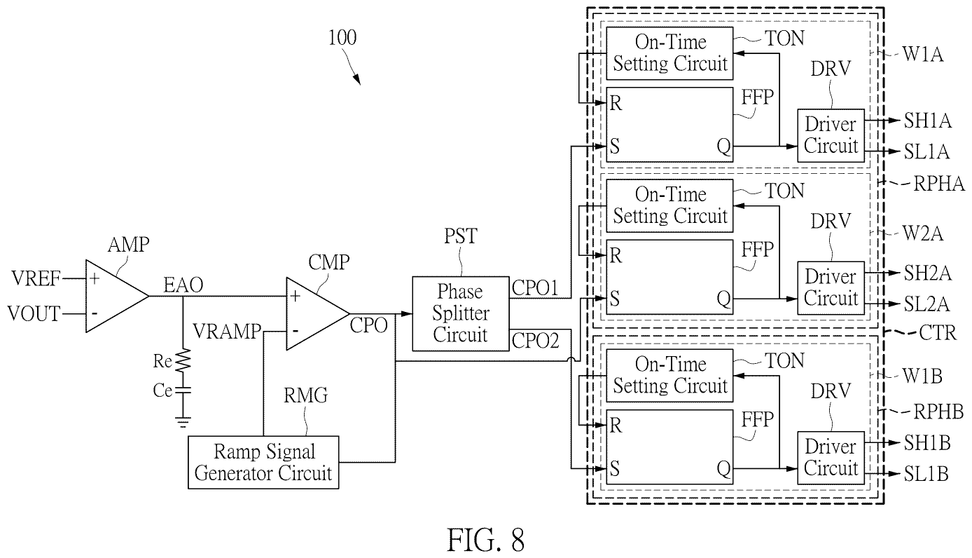

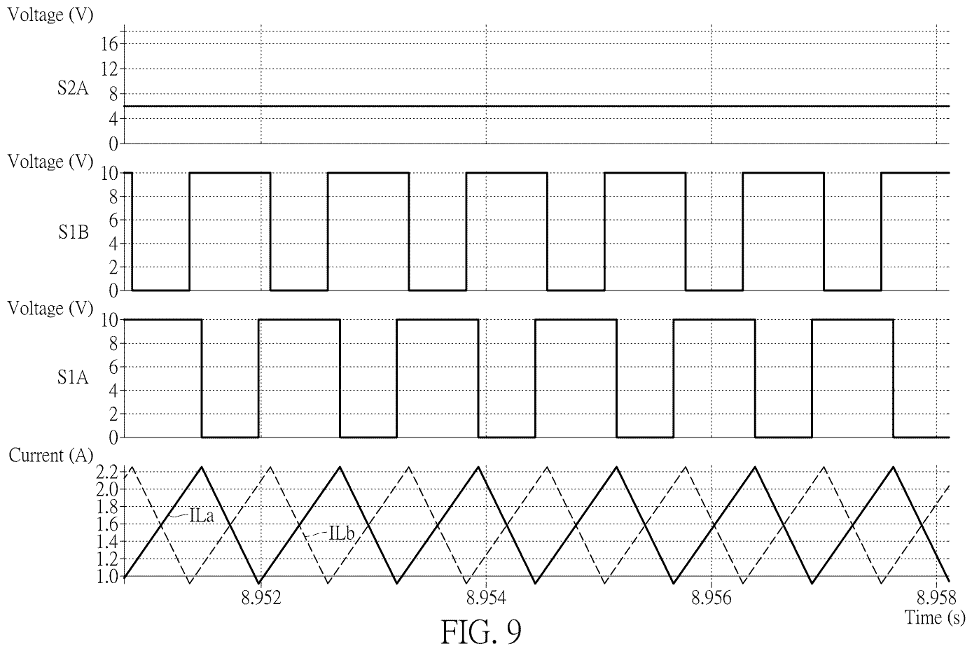

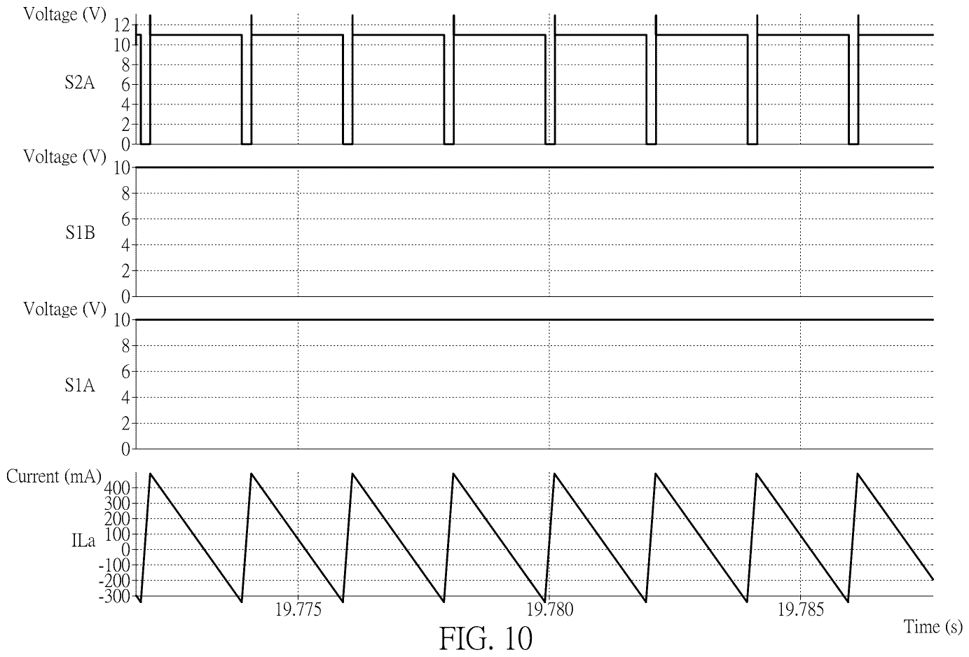

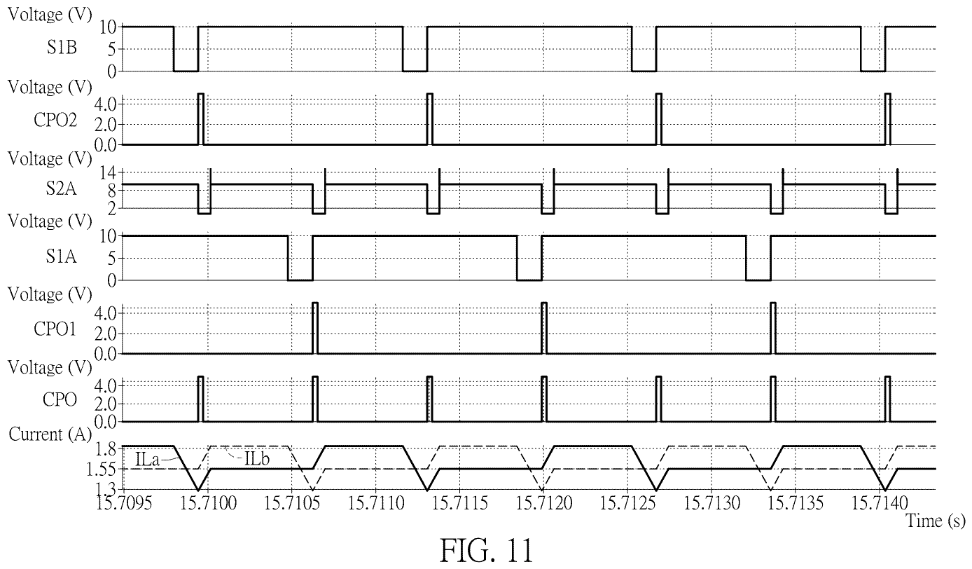

Reference is made to FIG. 7 to FIG. 11, in which FIG. 7 is a circuit diagram of a multi-phase power converter according to a second embodiment of the present disclosure, FIG. 8 is a circuit diagram of a control circuit of the multi-phase power converter according to the second embodiment of the present disclosure, FIG. 9 is a waveform diagram of signals of the multi-phase power converter in a buck mode according to the second embodiment of the present disclosure, FIG. 10 is a waveform diagram of signals of the multi-phase power converter in a boost mode according to the second embodiment of the present disclosure, and FIG. 11 is a waveform diagram of signals of the multi-phase power converter in a buck-boost mode according to the second embodiment of the present disclosure.

The descriptions of the second embodiment that are the same as the descriptions of the first embodiment are not repeated herein. In comparison with the first embodiment shown in FIG. 1, the multi-phase power converter of the second embodiment shown in FIG. 7 is also able to operate in the boost mode and the buck-boost mode, but mainly configured to operate in the buck mode and convert the input voltage VIN having a high voltage value into the output voltage VOUT having a low voltage value in the buck mode.

As shown in FIG. 7, in the second embodiment, the multi-phase power converter of the present disclosure includes two buck-side switch circuits, but only includes a boost-side switch circuit. One of the two buck-side switch circuits includes the buck high-side switch HS1A and the buck low-side switch LS1A. The other of the two buck-side switch circuits includes the buck high-side switch HS1B and the buck low-side switch LS1B. The boost-side switch circuit includes the boost high-side switch HS2A and the boost low-side switch LS2A.

The boost-side switch circuit that includes the boost high-side switch HS2B and the boost low-side switch LS2B is included in the multi-phase power converter of the first embodiment as shown in FIG. 1, but not included in that of the second embodiment as shown in FIG. 7. Correspondingly, the switch control circuit W2B that is configured to control the boost high-side switch HS2B and the boost low-side switch LS2B is included in the boost-buck control circuit CTR of the first embodiment as shown in FIG. 2, but not included in that of the second embodiment as shown in FIG. 8.

As shown in FIG. 7, the second terminal of the first inductor La is connected to the first terminal of the second inductor Lb. The second terminal of the second inductor Lb is connected to the first terminal of the buck low-side switch LS1B.

As shown in FIG. 8, the set terminal S of the on-time signal generator circuit FFP of the switch control circuit W2A is connected to the output terminal of the comparator CMP (instead of the phase splitter circuit PST as shown in FIG. 2). The on-time signal generator circuit FFP of the switch control circuit W2A outputs the on-time signal to the driver circuit DRV, according to the comparing signal CPO from the output terminal of the comparator CMP (instead of the phase split signal CPO1 as shown in FIG. 2) and the on-time set signal from the on-time setting circuit TON.

The phase splitter circuit PST shown in FIG. 8 splits the comparing signal CPO into the two phase split signals CPO1, CPO2 that do not overlap with each other as shown in FIG. 11.

A working period of each of a plurality of waveforms of the on-time signal is an on-time. The on-time of the on-time signal outputted by the on-time signal generator circuit FFP of the switch control circuit W2A shown in FIG. 8 is only half of that shown in FIG. 2.

In the buck mode, the first phase buck-side signal S1A, the second phase buck-side signal S1B, the first phase boost-side signal S2A, the current ILa flowing through the first inductor La and the current ILb flowing through the second inductor Lb are shown in FIG. 7 and FIG. 9.

In the boost mode, the first phase buck-side signal S1A, the second phase buck-side signal S1B, the first phase boost-side signal S2A, the current ILa and the current ILb are shown in FIG. 7 and FIG. 10.

In the buck-boost mode, the first phase buck-side signal S1A, the second phase buck-side signal S1B, the first phase boost-side signal S2A, the current ILa and the current ILb are shown in FIG. 7 and FIG. 11.

When the multi-phase power converter of the present disclosure includes the two buck-side switch circuits and the one boost-side switch circuit, a frequency of the first phase boost-side signal S2A is twice a frequency of the first phase buck-side signal S1A and twice a frequency of the second phase buck-side signal S1B.

It is worth noting that, in the multi-phase power converter of the second embodiment of the present disclosure, each of the plurality of waveforms of the currents ILa, ILb has the plurality of waveform segments, and the slopes of the plurality of waveform segments are different from each other. The slopes of the plurality of waveform segments of each one of the plurality of waveforms of each of the currents ILa, ILb are respectively equal to the slopes of the plurality of waveform segments of another of the plurality of waveforms of each of the currents ILa, ILb. Accordingly, the currents ILa, ILb of the multi-phase power converter of the present disclosure change stably.

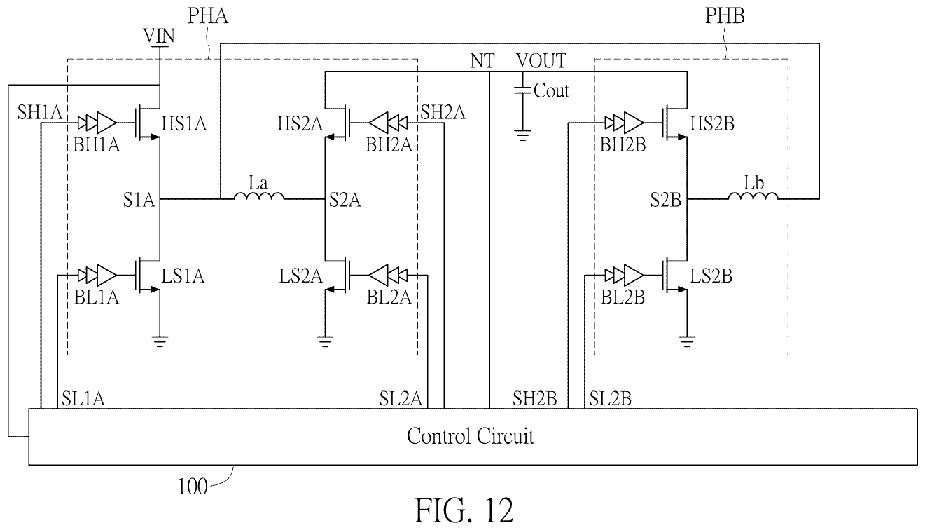

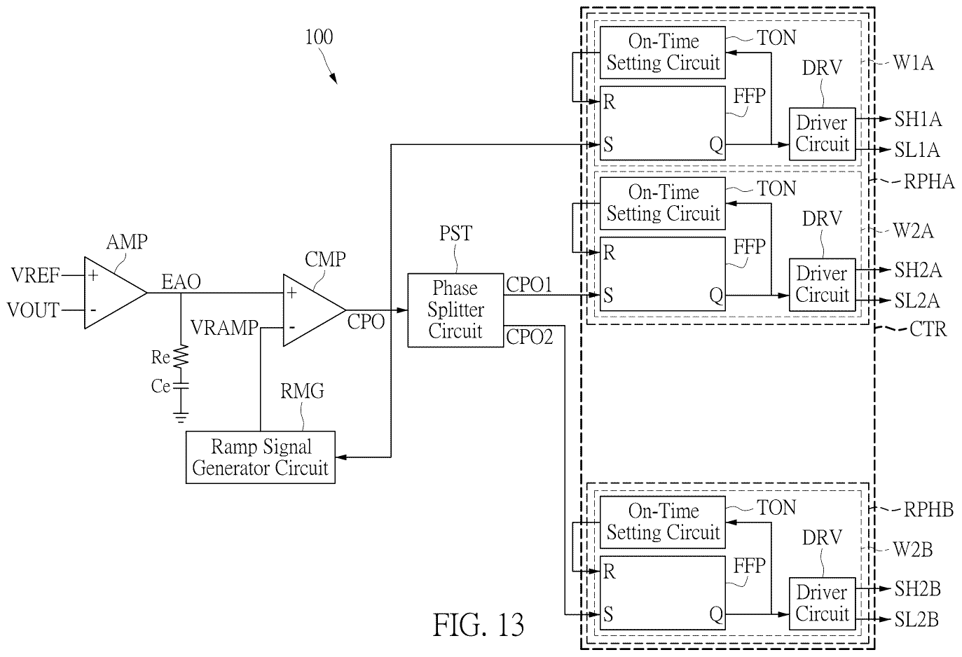

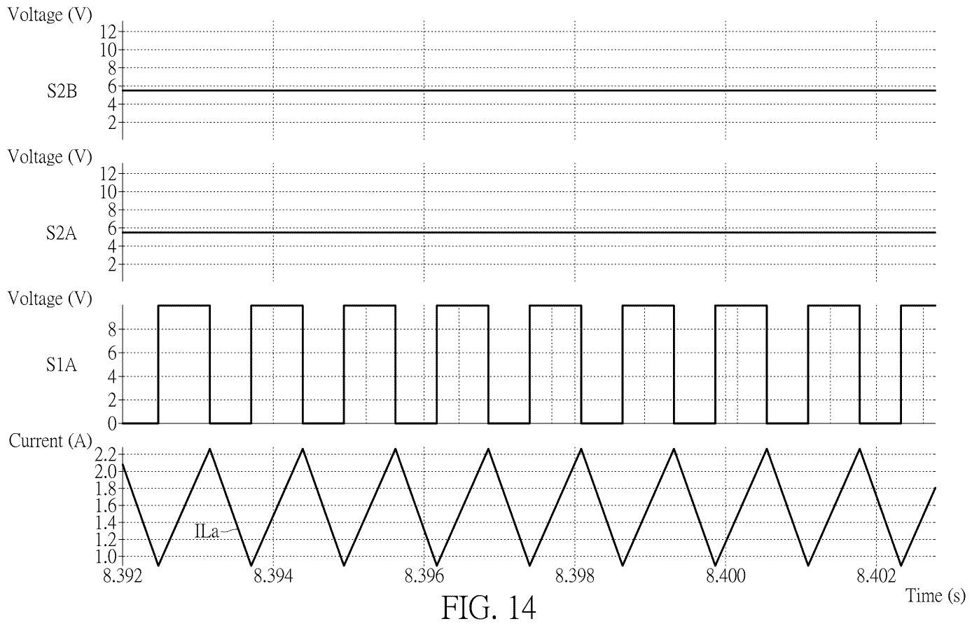

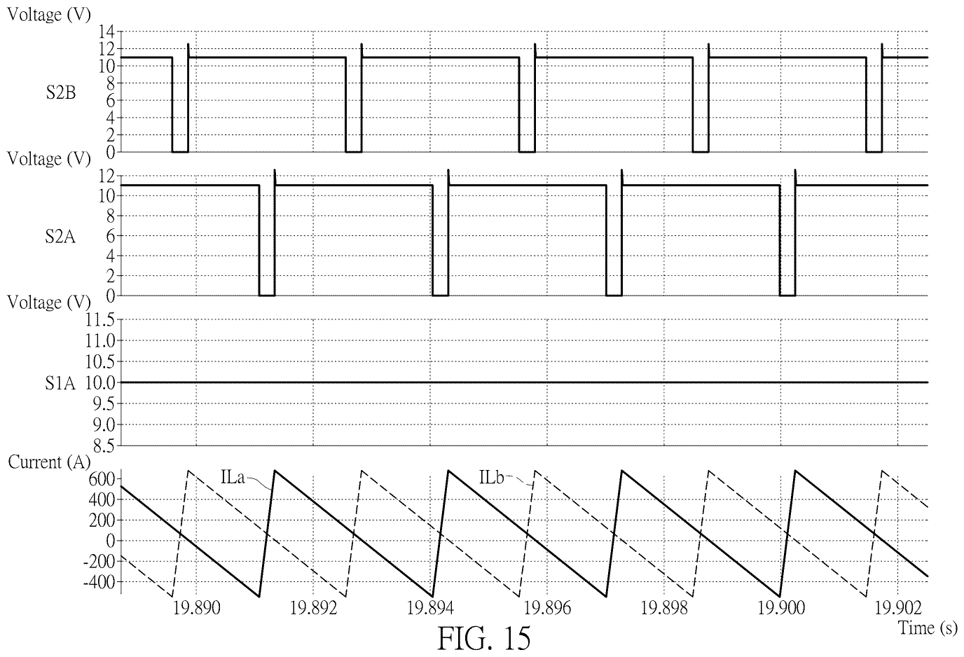

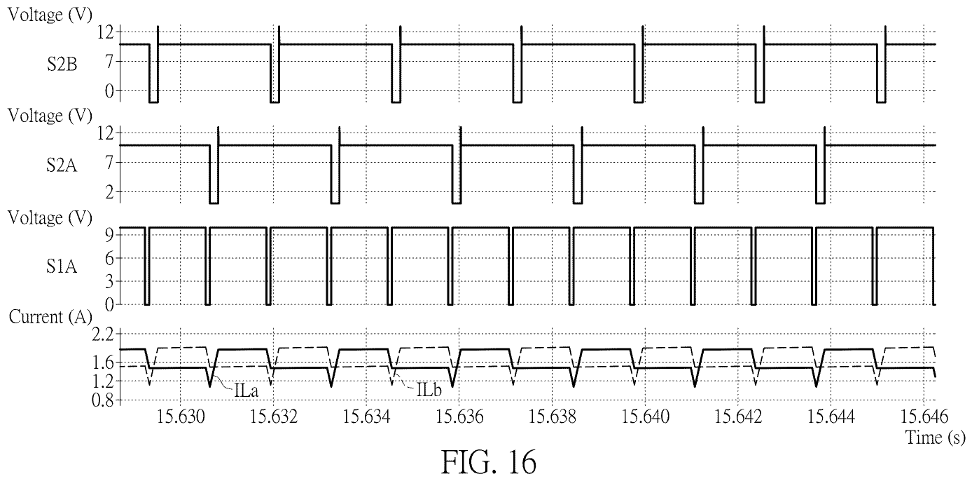

Reference is made to FIG. 12 to FIG. 16, in which FIG. 12 is a circuit diagram of a multi-phase power converter according to a third embodiment of the present disclosure, FIG. 13 is a circuit diagram of a control circuit of the multi-phase power converter according to the third embodiment of the present disclosure, FIG. 14 is a waveform diagram of signals of the multi-phase power converter in a buck mode according to the third embodiment of the present disclosure, FIG. 15 is a waveform diagram of signals of the multi-phase power converter in a boost mode according to the third embodiment of the present disclosure, and FIG. 16 is a waveform diagram of signals of the multi-phase power converter in a buck-boost mode according to the third embodiment of the present disclosure.

The descriptions of the third embodiment of the present disclosure that are the same as the descriptions of the first embodiment of the present disclosure are not repeated herein.

In comparison with the first embodiment shown in FIG. 1, the multi-phase power converter of the third embodiment of the present disclosure shown in FIG. 12 is also able to operate in the buck mode and the buck-boost mode, but is mainly configured to operate in the boost mode and convert the input voltage VIN having a low voltage value into the output voltage VOUT having a high voltage value in the boost mode.

As shown in FIG. 12, in the third embodiment, the multi-phase power converter of the present disclosure only includes one buck-side switch circuit and two boost-side switch circuits. One of the two boost-side switch circuits includes the boost high-side switch HS2A and the boost low-side switch LS2A. The other of the two boost-side switch circuits includes the boost high-side switch HS2B and the boost low-side switch LS2B. The buck-side switch circuit includes the boost high-side switch HS2A and the boost low-side switch LS2A.

The buck-side switch circuit that includes the buck high-side switch HS1B and the buck low-side switch LS1B is included in the multi-phase power converter of the first embodiment as shown in FIG. 1, but not included in that of the third embodiment as shown in FIG. 12. Correspondingly, the switch control circuit W1B that is configured to control the boost high-side switch HS1B and the boost low-side switch LS1B is included in the boost-buck control circuit CTR of the first embodiment as shown in FIG. 2, but not included in that of the third embodiment as shown in FIG. 13.

As shown in FIG. 12, the first terminal of the second inductor Lb is connected to the first terminal of the boost low-side switch LS2B, and the second terminal of the second inductor Lb is connected to the first terminal of the first inductor La.

As shown in FIG. 13, the set terminal S of the on-time signal generator circuit FFP of the switch control circuit W1A is connected to the output terminal of the comparator CMP (instead of the phase splitter circuit PST as shown in FIG. 2). The on-time signal generator circuit FFP of the switch control circuit W1A outputs the on-time signal to the driver circuit DRV, according to the comparing signal CPO from the output terminal of the comparator CMP (instead of the phase split signal CPO1 as shown in FIG. 2) and the on-time set signal from the on-time setting circuit TON.

The working period of each of the plurality of waveforms of the on-time signal is the on-time. The on-time of the on-time signal outputted by the on-time signal generator circuit FFP of the switch control circuit W2A shown in FIG. 13 is only half of that shown in FIG. 2.

In the buck mode, the first phase boost-side signal S2A, the second phase boost-side signal S2B, the first phase buck-side signal S1A, the current ILa flowing through the first inductor La and the current ILb flowing through the second inductor Lb are shown in FIG. 12 and FIG. 14.

In the boost mode, the first phase boost-side signal S2A, the second phase boost-side signal S2B, the first phase buck-side signal S1A, the current ILa and the current ILb are shown in FIG. 12 and FIG. 15.

In the buck-boost mode, the first phase boost-side signal S2A, the second phase boost-side signal S2B, the first phase buck-side signal S1A, the current ILa and the current ILb are shown in FIG. 12 and FIG. 16.

When the multi-phase power converter of the present disclosure includes the two boost-side switch circuits and the one buck-side switch circuit as shown in FIG. 12, the frequency of the first phase buck-side signal S1A is twice the frequency of the first phase boost-side signal S2A and twice a frequency of the second phase boost-side signal S2B.

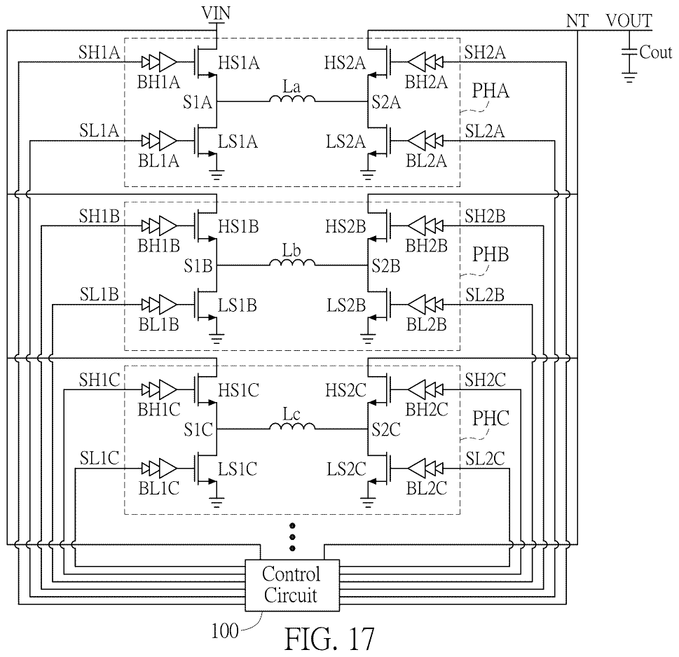

Reference is made to FIG. 17, which is a circuit diagram of a multi-phase power converter according to a fourth embodiment of the present disclosure.

As shown in FIG. 1, the multi-phase power converter of the first embodiment of the present disclosure only includes the two phase switch circuits that are the first phase switch circuit PHA and the second phase switch circuit PHB.

In contrast, as shown in FIG. 17, the multi-phase power converter of the fourth embodiment of the present disclosure only includes three phase switch circuits as the first phase switch circuit PHA, the second phase switch circuit PHB and a third phase switch circuit PHC, and three inductors as the first inductor La, the second inductor Lb and a third inductor Lc. In practice, the multi-phase power converter of the present disclosure may include more than three phase switch circuits and more than three inductors, and the number of the inductors depends on the number of the phase switch circuits.

The descriptions of the fourth embodiment of the present disclosure that are the same as the descriptions of the first embodiment of the present disclosure are not repeated herein.

As shown in FIG. 17, the third phase switch circuit PHC includes a buck high-side switch HS1C, a buck low-side switch LS1C, a boost high-side switch HS2C and a boost low-side switch LS2C.

A first terminal of the buck high-side switch HS1C is coupled to the input voltage VIN. A first terminal of the buck low-side switch LS1C is connected to a second terminal of the buck high-side switch HS1C and a first terminal of the third inductor Lc. A first terminal of the boost high-side switch HS2C is connected to the output node NT and the first terminal of the output capacitor Cout. A first terminal of the boost low-side switch LS2C is connected to a second terminal of the boost high-side switch HS2C and a second terminal of the third inductor Lc.

The control circuit 100 may be coupled to the input voltage VIN. The control circuit 100 is connected to the output node NT or the first terminal of the output capacitor Cout. The control circuit 100 uses the input voltage VIN, and outputs a plurality of control signals respectively to the control terminal of the buck high-side switch HS1C, the control terminal of the buck low-side switch LS1C, the control terminal of the boost high-side switch HS2C and the control terminal of the boost low-side switch LS2C according to the output voltage VOUT of the output node NT or the first terminal of the output capacitor Cout.

If necessary, the multi-phase power converter of the present disclosure may further include one buffer or a plurality of buffers, such as, but not limited to, a plurality of buffers BH1A, BL1A, BH2A, BL2A, BH1B, BL1B, BH2B, BL2B, BH1C, BL1C, BH2C, BL2C shown in FIG. 17. Input terminals of the plurality of buffers BH1C, BL1C, BH2C, BL2C are respectively connected to the output terminals of the control circuit 100. Output terminals of the plurality of buffers BH1C, BL1C, BH2C, BL2C are respectively connected to the control terminal of the buck high-side switch HS1C, the control terminal of the buck low-side switch LS1C, the control terminal of the boost high-side switch HS2C and the control terminal of the boost low-side switch LS2C.

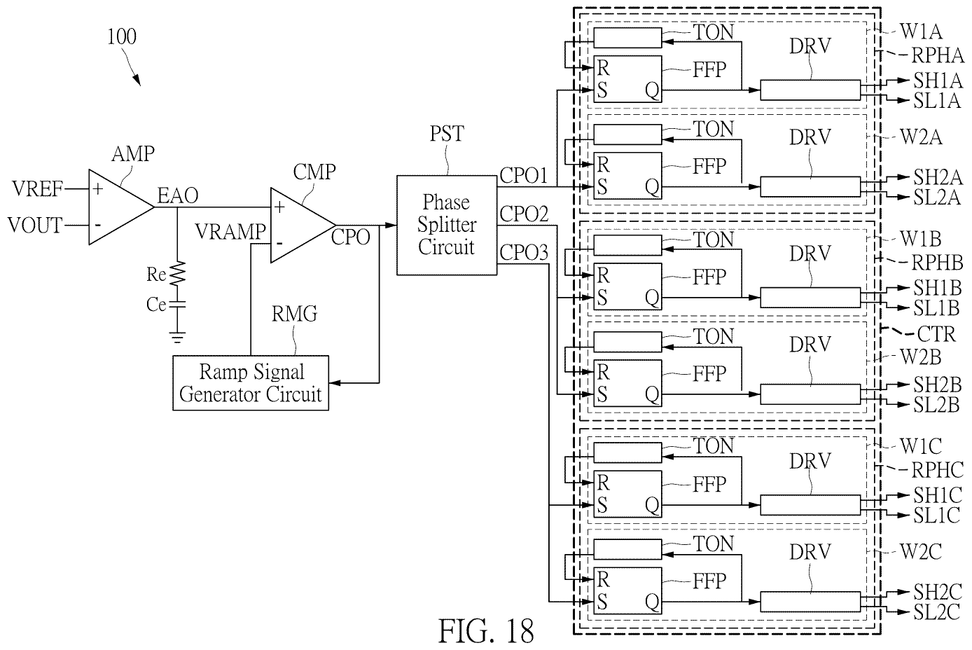

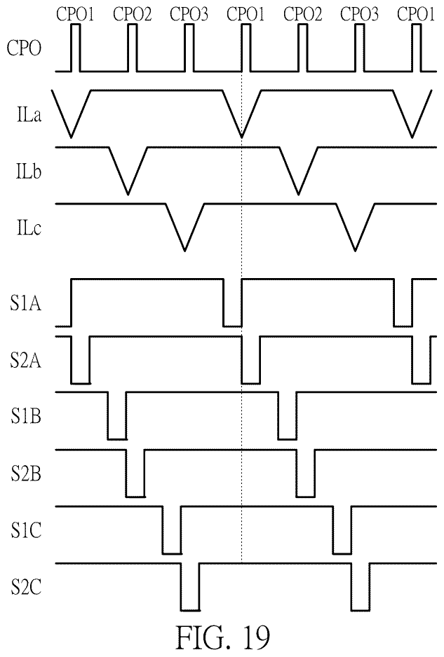

Reference is made to FIG. 17 to FIG. 19, in which FIG. 18 is a circuit diagram of a control circuit of the multi-phase power converter according to the fourth embodiment of the present disclosure, and FIG. 19 is a waveform diagram of signals of the multi-phase power converter according to the fourth embodiment of the present disclosure.

Fo example, the control circuit 100 shown in FIG. 17 may be the same as the control circuit 100 shown in FIG. 18. The boost-buck control circuit CTR of the control circuit 100 may include a plurality of phase switch circuits, such as, but not limited to, three phase switch circuits that are the first phase control circuit RPHA, the second phase control circuit RPHB and a third phase control circuit RPHC.

The phase splitter circuit PST shown in FIG. 18 obtains the comparing signal CPO from the output terminal of the comparator CMP, and splits the comparing signal CPO into three phase split signals CPO1, CPO2, CPO3. For example, as shown in FIG. 19, the phase splitter circuit PST alternately distributes the plurality of waveforms of the comparing signal CPO to the first phase control circuit RPHA, the second phase control circuit RPHB and the third phase control circuit RPHC. Therefore, in the multi-phase power converter, the first phase control circuit RPHA, the second phase control circuit RPHB and the third phase control circuit RPHC are alternately controlled.

The third phase control circuit RPHC includes two switch control circuits W1C, W2C. The switch control circuit W1C is a buck-side control circuit, and the switch control circuit W2C is a boost-side control circuit.

In each of the two buck-side control circuits W1C, W2C, the on-time signal generator circuit FFP outputs the on-time signal based on the phase split signal CPO3 from the phase splitter circuit PST and the on-time set signal from the on-time setting circuit TON.

The driver circuit DRV of the switch control circuit W1C shown in FIG. 18, according to the on-time signal from the on-time signal generator circuit FFP, outputs two control signals SH1C, SL1C respectively to the control terminal of the buck high-side switch HS1C and the control terminal of the buck low-side switch LS1C as shown in FIG. 17.

The driver circuit DRV of the switch control circuit W2C shown in FIG. 18, according to the on-time signal from the on-time signal generator circuit FFP, outputs two control signals SH2C, SL2C respectively to the control terminal of the boost high-side switch HS2C and the control terminal of the boost low-side switch LS2C as shown in FIG. 17.

The first phase buck-side signal S1A, the first phase boost-side signal S2A, the second phase buck-side signal S1B, the second phase boost-side signal S2B, a third phase buck-side signal S1C and a third phase boost-side signal S2C as shown in FIG. 17 have a plurality of waveforms shown in FIG. 19.

The current ILa flowing through the first inductor La, the current Ilb flowing through the second inductor Lb, and a current ILc flowing through the third inductor Lc are shown in FIG. 17 and FIG. 19.

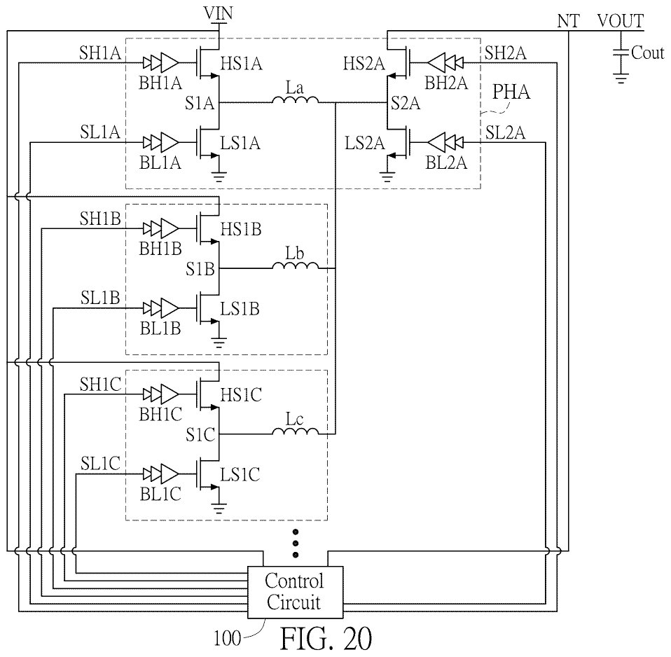

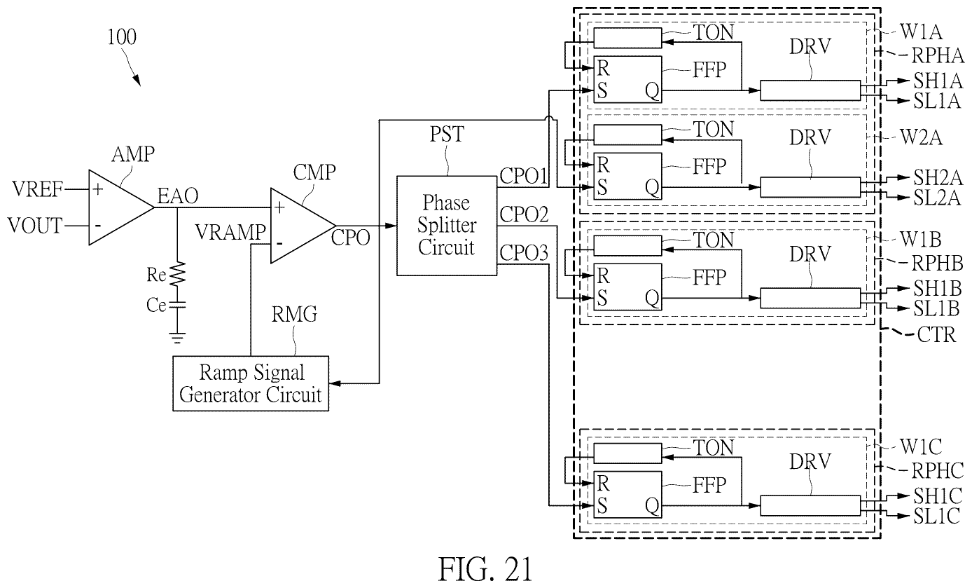

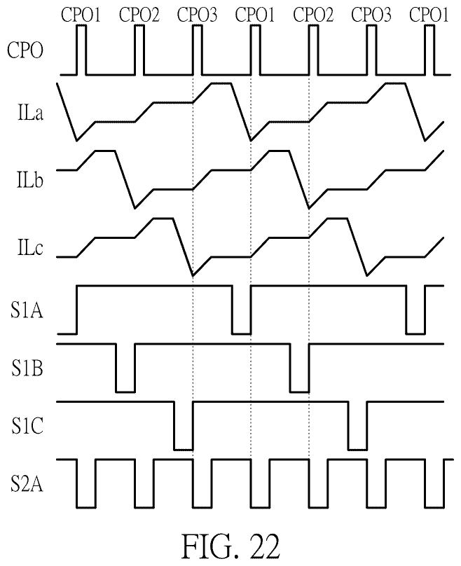

Reference is made to FIG. 20 to FIG. 22, in which FIG. 20 is a circuit diagram of a multi-phase power converter according to a fifth embodiment of the present disclosure, FIG. 21 is a circuit diagram of a control circuit of the multi-phase power converter according to the fifth embodiment of the present disclosure; and FIG. 22 is a waveform diagram of signals of the multi-phase power converter according to the fifth embodiment of the present disclosure.

The descriptions of the fifth embodiment of the present disclosure that are the same as the descriptions of the first to fourth embodiments of the present disclosure are not repeated herein.

A difference between the fifth and fourth embodiments is that, as shown in FIG. 20, in the multi-phase power converter of the fifth embodiment, the second phase switch circuit PHB includes the buck high-side switch HS1B and the buck low-side switch LS1B but not the boost high-side switch HS2B and the boost low-side switch LS2B that are shown in FIG. 18, and the third phase switch circuit PHC includes the buck high-side switch HS1C and the buck low-side switch LS1C but not the boost high-side switch HS2C and the boost low-side switch LS2C that are shown in FIG. 18.

Correspondingly, in the control circuit 100 shown in FIG. 21, the boost-buck control circuit CTR only includes three buck-side control circuits as the switch control circuits W1A, W1B, W1C, and one boost-side control circuit as the switch control circuit W2A. The switch control circuit W2B and the switch control circuit W2C as two boost-side control circuits are included in the boost-buck control circuit CTR of the fourth embodiment as shown in FIG. 18, but not included in the boost-buck control circuit CTR of the fifth embodiment as shown in FIG. 21.

The phase splitter circuit PST shown in FIG. 21 splits the comparing signal CPO into the three phase split signals CPO1, CPO2, CPO3 that do not overlap with each other as shown in FIG. 22.

As shown in FIG. 20, the second terminal of the second inductor Lb and the second terminal of the third inductor Lc are connected to the second terminal of the first inductor La and the first terminal of the boost low-side switch LS2A.

The first phase buck-side signal S1A, the first phase boost-side signal S2A, the second phase buck-side signal S1B, the third phase buck-side signal S1C, the current ILa flowing through the first inductor La, the current ILb flowing through the second inductor Lb and the current ILc flowing through the third inductor Lc are shown in FIG. 20 and FIG. 22.

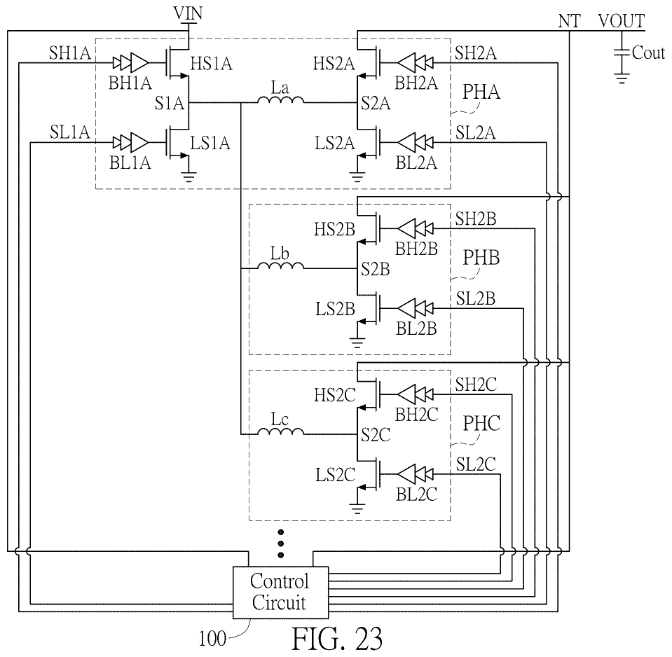

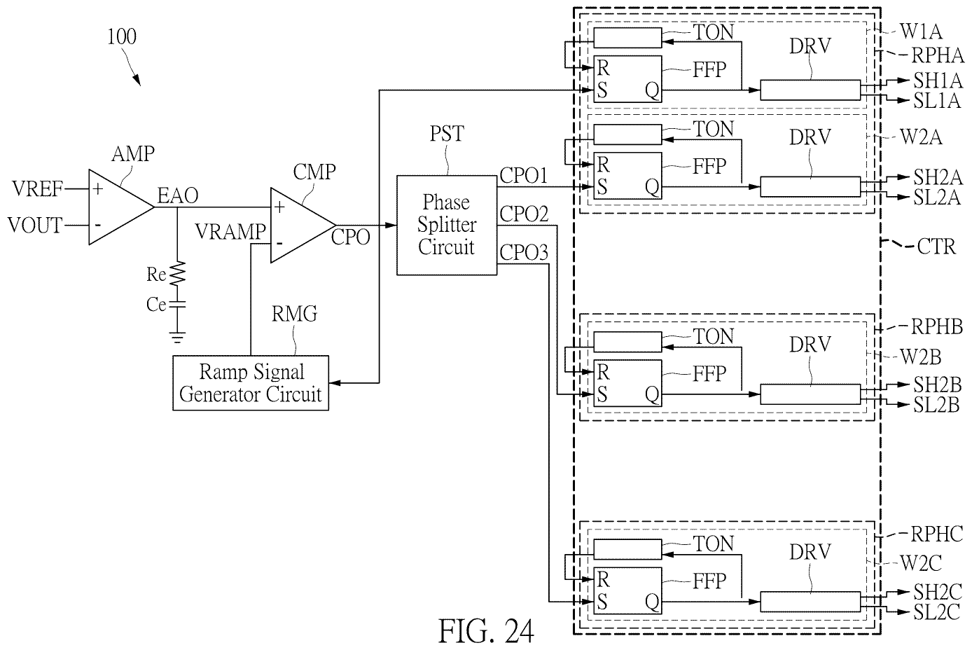

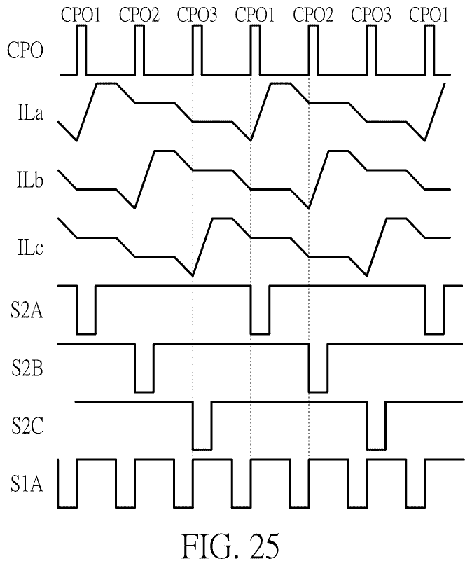

Reference is made to FIG. 23 to FIG. 25, in which FIG. 23 is a circuit diagram of a multi-phase power converter according to a sixth embodiment of the present disclosure, FIG. 24 is a circuit diagram of a control circuit of the multi-phase power converter according to the sixth embodiment of the present disclosure, and FIG. 25 is a waveform diagram of signals of the multi-phase power converter according to the sixth embodiment of the present disclosure.

The descriptions of the sixth embodiment of the present disclosure that are the same as the descriptions of the first to fourth embodiments of the present disclosure are not repeated herein.

A difference between the sixth and the fourth embodiments is that, as shown in FIG. 20, in the multi-phase power converter of the sixth embodiment, the second phase switch circuit PHB includes the boost high-side switch HS2B and the boost low-side switch LS2B but not the buck high-side switch HS1B and the buck low-side switch LS1B that are shown in FIG. 18, and the third phase switch circuit PHC includes the boost high-side switch HS2C and the boost low-side switch LS2C but not the buck high-side switch HS1C and the buck low-side switch LS1C that are shown in FIG. 18.

Correspondingly, in the control circuit 100 shown in FIG. 24, the boost-buck control circuit CTR only includes one buck-side control circuit as the switch control circuit W1A. and three boost-side control circuits as the switch control circuits W2A, W2B, W2C. The two buck-side control circuits that are the switch control circuits W1B, W1C are included in the boost-buck control circuit CTR of the fourth embodiment shown in FIG. 18, but not included in that of the sixth embodiment shown in FIG. 24.

The phase splitter circuit PST shown in FIG. 24 splits the comparing signal CPO into the three phase split signals CPO1, CPO2, CPO3 that do not overlap with each other as shown in FIG. 25.

As shown in FIG. 23, the first terminal of the second inductor Lb and the second terminal of the third inductor Lc are connected to the first terminal of the first inductor La and the first terminal of the buck low-side switch LS1A.

The first phase buck-side signal S1A, the first phase boost-side signal S2A, the second phase boost-side signal S2B, the third phase boost-side signal S2C, the current ILa flowing through the first inductor La, the current ILb flowing through the second inductor Lb and the current ILc flowing through the third inductor Lc are shown in FIG. 23 and FIG. 25.

Each of the plurality of waveforms of the currents ILa, ILb, ILc has a plurality of waveform segments, and the slopes of the plurality of waveform segments are different from each other. The slopes of the plurality of waveform segments of each one of the plurality of waveforms of each of the currents ILa, ILb, ILc are respectively equal to the slopes of the plurality of waveform segments of another of the plurality of waveforms of each of the currents ILa, ILb, ILc. Accordingly, the currents ILa, ILb, ILc of the multi-phase power converter of the present disclosure change stably.

In conclusion, the present disclosure provides the multi-phase power converter. The multi-phase power converter of the present disclosure includes the plurality of phase switch circuits. In the multi-phase power converter of the present disclosure, the control circuit performs phase-splitting control on the plurality of phase switching circuits. The multi-phase power converter switches between the boost mode, the buck mode and the buck-boost mode, and supplies appropriate voltages. The multi-phase power converter of the present disclosure only includes two phase switch circuits or can be easily scaled to include more phase switch circuits for different practical applications. Furthermore, in multi-phase power converter of the present disclosure, the number of the buck-side switch circuits and the number of the boost-side switch circuits of each of the plurality of phase switch circuits depend on the boost mode or buck mode as a main application requirement.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A multi-phase power converter, comprising:
a plurality of phase switch circuits;
a control circuit; and
a plurality of inductors each including a first terminal and a second terminal;
wherein each of the plurality of phase switch circuits includes two buck-side switches respectively as:
a buck high-side switch, wherein a first terminal of the buck high-side switch is coupled to an input voltage; and
a buck low-side switch, wherein a first terminal of the buck low-side switch is connected to a second terminal of the buck high-side switch, and a second terminal of the buck low-side switch is grounded;
wherein the first terminals of the buck high-side switches of the plurality of phase switch circuits are respectively connected to the first terminals of the plurality of inductors;
wherein each of the plurality of phase switch circuits includes two boost-side switches respectively as:
a boost high-side switch, wherein a first terminal of the boost high-side switch is connected to an output node; and
a boost low-side switch, wherein a first terminal of the boost low-side switch is connected to a second terminal of the boost high-side switch, and a second terminal of the boost low-side switch is grounded;
wherein the first terminals of the boost low-side switches of the plurality of phase switch circuits are respectively connected to the second terminals of the plurality of inductors;
wherein the control circuit is connected to a control terminal of each of the two buck-side switches of each of the plurality of phase switch circuits, a control terminal of each of the two boost-side switches of each of the plurality of phase switch circuits and the output node, and the control circuit is configured to control the two buck-side switches and the two boost-side switches of each of the plurality of phase switch circuits according to an output voltage of the output node.

2. The multi-phase power converter according to claim 1, further comprising:
an output circuit connected between the output node and a ground.

3. The multi-phase power converter according to claim 1, wherein the control circuit includes:
an error amplifier, wherein a first input terminal of the error amplifier is coupled to a reference voltage, and a second input terminal of the error amplifier is connected to the output node;
a comparator, wherein a first input terminal of the comparator is connected to an output terminal of the error amplifier, and a second input terminal of the comparator is coupled to a ramp voltage;
a phase splitter circuit connected to an output terminal of the comparator, wherein the phase splitter circuit is configured to receive a comparing signal from the output terminal of the comparator and split the comparing signal into a plurality of phase split signals, and the plurality of phase split signals respectively correspond to the plurality of phase switch circuits; and
a boost-buck control circuit, wherein the boost-buck control circuit is connected to the phase splitter circuit, is connected to the control terminals of the two buck-side switches and the two boost-side switches of each of the plurality of phase switch circuits, and is configured to control each of the plurality of phase switch circuits according to a corresponding one of the plurality of phase split signals.

4. The multi-phase power converter according to claim 3, wherein the boost-buck control circuit includes a plurality of phase control circuits that are respectively configured to receive the plurality of phase split signals;
wherein each of the plurality of phase control circuits includes two switch control circuits, and each of the two switch control circuits includes:
an on-time setting circuit configured to output an on-time set signal;
an on-time signal generator circuit connected to the phase splitter circuit and the on-time setting circuit, wherein the on-time signal generator circuit is configured to output an on-time signal based on the phase split signal and the on-time set signal; and
a driver circuit, wherein the driver circuit is connected to the on-time signal generator circuit, is connected to the control terminal of one of the plurality of buck-side switches and the control terminal of one of the plurality of boost-side switches of the plurality of phase switch circuits, and is configured to control the one of the plurality of buck-side switches and the one of the plurality of boost-side switches according to the on-time signal.

5. A multi-phase power converter, comprising:
two phase switch circuits respectively as a first phase switch circuit and a second phase switch circuit; and
a control circuit;
wherein each of the plurality of phase switch circuits includes two buck-side switches respectively as:
a buck high-side switch, wherein a first terminal of the buck high-side switch is coupled to an input voltage; and
a buck low-side switch, wherein a first terminal of the buck low-side switch is connected to a second terminal of the buck high-side switch, and a second terminal of the buck low-side switch is grounded;
wherein the first phase switch circuit further includes two boost-side switches respectively as:
a boost high-side switch, wherein a first terminal of the boost high-side switch is connected to an output node; and
a boost low-side switch, wherein a first terminal of the boost low-side switch is connected to a second terminal of the boost high-side switch, and a second terminal of the boost low-side switch is grounded;
wherein the first terminal of the buck low-side switch of the first phase switch circuit is connected to a first terminal of a first inductor, and the first terminal of the boost low-side switch is connected to a second terminal of the first inductor;
wherein the second terminal of the first inductor is further connected to a first terminal of a second inductor, and a second terminal of the second inductor is connected to the first terminal of the buck low-side switch of the second phase switch circuit;
wherein the control circuit is connected to a control terminal of each of the two buck high-side switches of each of the plurality of phase switch circuits, a control terminal of each of the two boost-side switches and the output node, and is configured to control the two buck high-side switches of each of the plurality of phase switch circuits and the two boost-side switches according to an output voltage of the output node.

6. The multi-phase power converter according to claim 5, further comprising:
an output circuit connected between the output node and a ground.

7. The multi-phase power converter according to claim 5, wherein the control circuit includes:
an error amplifier, wherein a first input terminal of the error amplifier is coupled to a reference voltage, and a second input terminal of the error amplifier is connected to the output node;
a comparator, wherein a first input terminal of the comparator is connected to an output terminal of the error amplifier, and a second input terminal of the comparator is coupled to a ramp voltage;
a phase splitter circuit connected to an output terminal of the comparator, wherein the phase splitter circuit is configured to receive a comparing signal from the output terminal of the comparator and split the comparing signal into a first phase split signal and a second phase split signal; and
a boost-buck control circuit connected to the phase splitter circuit, the control terminals of the two buck-side switches of each of the plurality of phase switch circuits, the control terminals of the two boost-side switches, and the output terminal of the comparator, wherein the boost-buck control circuit is configured to:
control the two buck-side switches of the first phase switch circuit according to the first phase split signal;
control the two boost-side switches according to the comparing signal; and
control the two buck-side switches of the second phase switch circuit according to the second phase split signal.

8. The multi-phase power converter according to claim 7, wherein the boost-buck control circuit includes two phase control circuits, and each of the two phase control circuits includes a plurality of switch control circuits respectively as a first phase buck-side control circuit, a first phase boost-side control circuit, and a second phase buck-side control circuit;
wherein the first phase buck-side control circuit is connected to the phase splitter circuit and the control terminals of the two buck-side switches of the first phase switch circuit, and configured to control the two buck-side switches of the first phase switch circuit according to the first phase split signal;
wherein the first phase boost-side control circuit is connected to the output terminal of the comparator and the control terminals of the two boost-side switches, and configured to control the two boost-side switches according to the comparing signal;
wherein the second phase buck-side control circuit is connected to the phase splitter circuit and the control terminals of the two buck-side switches of the second phase switch circuit, and configured to control the two buck-side switches of the second phase switch circuit according to the second phase split signal.

9. The multi-phase power converter according to claim 8, wherein each of the plurality of switch control circuits includes an on-time signal generator circuit and a driver circuit that are connected to each other;
wherein the plurality of on-time signal generator circuits of the plurality of switch control circuits are respectively configured to output a plurality of on-time signals based on the first phase split signal, the comparing signal, and the second phase split signal;
wherein the driver circuit of the first phase buck-side control circuit is configured to control the two buck-side switches of the first phase switch circuit according to the on-time signal that is outputted based on the first phase split signal;
wherein the driver circuit of the first phase boost-side control circuit is configured to control the two boost-side switches according to the on-time signal that is outputted based on the comparing signal;
wherein the driver circuit of the second phase buck-side control circuit is configured to control the two buck-side switches of the second phase switch circuit according to the on-time signal that is outputted based on the second phase split signal.

10. The multi-phase power converter according to claim 9, wherein each of the plurality of switch control circuits further includes an on-time setting circuit, and the on-time setting circuit is connected to the on-time signal generator circuit and configured to output an on-time set signal;
wherein the on-time signal generator circuit is configured to output the on-time signal based on the on-time set signal.

11. A multi-phase power converter, comprising:
two phase switch circuits respectively as a first phase switch circuit and a second phase switch circuit; and
a control circuit;
wherein each of the plurality of phase switch circuits includes two boost-side switches respectively as:
a boost high-side switch, wherein a first terminal of the boost high-side switch is connected to an output node; and
a boost low-side switch, wherein a first terminal of the boost low-side switch is connected to a second terminal of the boost high-side switch, and a second terminal of the boost low-side switch is grounded;
wherein the first phase switch circuit includes two buck-side switches respectively as:
a buck high-side switch, wherein a first terminal of the buck high-side switch is coupled to an input voltage;
a buck low-side switch, wherein a first terminal of the buck low-side switch is connected to a second terminal of the buck high-side switch, and a second terminal of the buck low-side switch is grounded;
wherein the first terminal of the buck low-side switch is connected to a first terminal of a first inductor, and the first terminal of the boost low-side switch of the first phase switch circuit is connected to a second terminal of the first inductor;
wherein the first terminal of the boost low-side switch of the second phase switch circuit is connected to a first terminal of a second inductor, and a second terminal of the second inductor is connected to the first terminal of the first inductor;
wherein the control circuit is connected to a control terminal of each of the two boost-side switches of each of the plurality of phase switch circuits, a control terminal of each of the two buck-side switches, and the output node, and the control circuit is configured to control the two boost-side switches of each of the plurality of phase switch circuits and the two buck-side switches according to an output voltage of the output node.

12. The multi-phase power converter according to claim 11, wherein the control circuit includes:
an error amplifier, wherein a first input terminal of the error amplifier is coupled to a reference voltage, and a second input terminal of the error amplifier is connected to the output node;
a comparator, wherein a first input terminal of the comparator is connected to an output terminal of the error amplifier, and a second input terminal of the comparator is coupled to a ramp voltage;
a phase splitter circuit connected to an output terminal of the comparator, wherein the phase splitter circuit is configured to receive a comparing signal from the output terminal of the comparator and split the comparing signal into a first phase split signal and a second phase split signal; and
a boost-buck control circuit connected to the control terminals of the two boost-side switches of each of the plurality of phase switch circuits, the control terminals of the two buck-side switches, the output terminal of the comparator, and the phase splitter circuit, wherein the boost-buck control circuit is configured to:
control the two buck-side switches of the first phase switch circuit according to the comparing signal;
control the two boost-side switches of the first phase switch circuit according to the first phase split signal; and
control the two boost-side switches of the second phase switch circuit according to the second phase split signal.

13. The multi-phase power converter according to claim 12, wherein the boost-buck control circuit includes two phase control circuits, and each of the two phase control circuits includes a plurality of switch control circuits respectively as a first phase buck-side control circuit, a first phase boost-side control circuit, and a second phase boost-side control circuit;
wherein the first phase buck-side control circuit is connected to the output terminal of the comparator and the control terminals of the two buck-side switches of the first phase switch circuit, and configured to control the two buck-side switches of the first phase switch circuit according to the comparing signal;
wherein the first phase boost-side control circuit is connected to the phase splitter circuit and the control terminals of the two boost-side switches of the first phase switch circuit, and configured to control the two boost-side switches of the first phase switch circuit according to the first phase split signal;
wherein the second phase boost-side control circuit is connected to the phase splitter circuit and the control terminals of the two boost-side switches of the second phase switch circuit, and configured to control the two boost-side switches of the second phase switch circuit according to the second phase split signal.

14. The multi-phase power converter according to claim 13, wherein each of the plurality of switch control circuits includes an on-time signal generator circuit and a driver circuit that are connected to each other;
wherein the plurality of on-time signal generator circuits of the plurality of switch control circuits are respectively configured to output a plurality of on-time signals based on the comparing signal, the first phase split signal, and the second phase split signal;
wherein the driver circuit of the first phase buck-side control circuit is configured to control the two buck-side switches according to the on-time signal that is outputted based on the comparing signal;
wherein the driver circuit of the first phase boost-side control circuit is configured to control the two boost-side switches of the first phase switch circuit according to the on-time signal that is outputted based on the first phase split signal;
wherein the driver circuit of the second phase boost-side control circuit is configured to control the two boost-side switches of the second phase switch circuit according to the on-time signal that is outputted based on the second phase split signal.

15. The multi-phase power converter according to claim 14, wherein each of the plurality of switch control circuits further includes an on-time setting circuit, and the on-time setting circuit is connected to the on-time signal generator circuit and configured to output an on-time set signal;
wherein the on-time signal generator circuit is configured to output the on-time signal based on the on-time set signal.
